(19) United States
(12) Patent Application Publication
(10) Pub. No.: US 2015/0003491 A1
(43) Pub. Date: Jan. 1, 2015

(54) TEMPERATURE MEASURING DEVICE AND TEMPERATURE MEASURING METHOD

(71) Applicant: FUJITSU LIMITED, Kawasaki-shi (JP)

(72) Inventor: Hidenori Matsumoto, Kawasaki (JP)

(73) Assignee: FUJITSU LIMITED, Kawasaki-shi (JP)

(21) Appl. No.: 14/294,782

(22) Filed: Jun. 3, 2014

(30) Foreign Application Priority Data
Jun. 27, 2013 (JP) 2013-134906

(51) Int. Cl. G01K 15/00

(52) U.S. Cl. CPC G01K 15/005
USPC 374/1

(57) ABSTRACT

A temperature measuring device includes a reading unit configured to read a first temperature value from a first temperature sensor that measures a temperature of a heat generating component and a second temperature value from a second temperature sensor that measures an ambient temperature, a calculation unit configured to calculate a correction value from an elapsed time and the first and the second temperature values, and a correction unit configured to calculate an corrected ambient temperature by correcting the second temperature value using the correction value obtained by the calculation unit.

### CROSS-REFERENCE TO RELATED APPLICATION

This application is based upon and claims the benefit of priority from the prior Japanese Patent Application No. 2013-134906 filed on Jun. 27, 2013, the entire contents of which are incorporated herein by reference.

### FIELD

The embodiments discussed herein are related to a temperature measuring device and a temperature measuring method.

### BACKGROUND

In a storage device, a temperature sensor for measuring ambient temperature is provided on, for example, a panel board, on which an LED for displaying a system status, a switch, and the like are mounted, in order to control a cooling fan. FIG. 11 illustrates a hardware configuration of a conventional storage device 101. The storage device 101 includes a housing 102.

The storage device 101 includes a mid-plane board (hereinafter also referred to as MP) 104 and controller modules (CMs) 103-1 and 103-2 inside the housing 102 and includes a panel board 105 outside the housing 102. The MP 104 is a circuit board including a plurality of connectors on both sides thereof, inter-connects circuit boards inserted into the connectors, and functions as a backbone of the storage device 101. In the present example, the CMs 103-1 and 103-2 described later, a hard disk drive (HDD) not illustrated in the drawings, and a power supply not illustrated in the drawings are mounted on the MP 104. Further, the MP 104 includes a temperature sensor element 109 described later and an inter-integrated circuit (I²C) (registered trademark) bus 112.

The CMs 103-1 and 103-2 control write and read of data to and from the HDD not illustrated in the drawings according to, for example, a request from a server device not illustrated in the drawings. The CM 103-1 includes an expander chip (EXP) 110-1, a central processing unit (CPU) 113-1, and a memory 114-1. The CM 103-2 includes an EXP 110-2, a CPU 113-2, and a memory 114-2.

The EXPs 110-1 and 110-2 are chips for performing input/output between the CMs 103-1 and 130-2 and an external device. The CPUs 113-1 and 113-2 are processing devices that perform various processes by executing programs stored in the memories 114-1 and 114-2 described later. Known CPUs may be used as the CPUs 113-1 and 113-2.

The memories 114-1 and 114-2 stores programs executed by the CPUs 113-1 and 113-2, various data, and data obtained by operations of the CPUs 113-1 and 113-2. Various existing memories such as, for example, a random access memory (RAM) and a read only memory (ROM) may be used as the memories 114-1 and 114-2. A plurality of types of memories may be included.

The panel board 105 includes a light-emitting diode (LED) 106 that indicates a conduction state and an operation state (power-on, fault, cache, and the like) of the storage device 101. The panel board 105 further includes a temperature sensor 107 for monitoring an ambient temperature of the storage device 101. For example, a transistor may be used as the temperature sensor 107.

The temperature sensor 107 is connected to the temperature sensor element 109 on the MP 104 through a wire connection 115. The temperature sensor element 109 is connected to the EXPs 110-1 and 110-2 through the I²C bus 112. The EXPs 110-1 and 110-2 may read a value of temperature measured by the temperature sensor 107 through the temperature sensor element 109 by accessing the temperature sensor element 109.

The temperature sensor element 109 includes an interface for outputting temperature date from the temperature sensor 107. The temperature sensor element 109 may include a register for correcting the temperature.

Japanese Laid-open Patent Publication No. 2006-184129 is an example of related art.

In the configuration described in the Background, the LED 106 on the panel board 105 generates heat when emitting light. Therefore, the heat generated from the LED 106 is received by the temperature sensor 107 for measuring ambient temperature. As a result, a temperature higher than a correct ambient temperature is detected as the ambient temperature. Therefore, conventionally, a method is employed in which a correction value (hereinafter also referred to as an offset value) Tt determined according to time is applied to a read temperature T2 of the temperature sensor 107 for measuring the ambient temperature to reduce influence of the LED 106 to the ambient temperature.

Specifically, there is used a temperature correction table representing a relationship between an elapsed time from a time of power-on (P-ON) of the storage device 101 and the correction value. FIG. 12 illustrates an example of such a temperature correction table. For example, a table value (a correction value) Tt as illustrated in FIG. 12 is obtained based on the elapsed time from power-on (P-ON) of the storage device 101 and the Tt is subtracted from the temperature T2 detected by the temperature sensor 107.

As a result, an ambient temperature Tc after correction may be obtained by the expression 1 below.

Tc=T2−Tt (Expression 2)

Thereby, it is possible to subtract the heat generated from the LED 106.

The temperature correction table illustrated in FIG. 12 is created based on measured values obtained in a test and stored in the storage device 101 at the time of shipment from a factory.

FIG. 13 illustrates a temperature measuring process in a conventional method.

In step S101, counting of an elapsed time t (for example, seconds) from the power-on of the storage device 101 is started.

In step S102, the ambient temperature T2 is read from the temperature sensor 107.

Next, in step S103, the correction value Tt used for the correction is obtained from the temperature correction table based on the elapsed time t from the power-on of the device.

In step S104, the ambient temperature after correction is calculated by subtracting the correction value Tt obtained in step S103 from the T2 read in step S102.

### SUMMARY

According to an aspect of the invention, a temperature measuring device includes a reading unit configured to read a first temperature value from a first temperature sensor that measures a temperature of a heat generating component and a second temperature value from a second temperature sensor that measures an ambient temperature, a calculation unit configured to calculate a correction value from an elapsed time and the first and the second temperature values, and a correction unit configured to calculate an corrected ambient temperature by correcting the second temperature value using the correction value obtained by the calculation unit.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a schematic diagram illustrating a hardware configuration of a storage device that is an example of a first embodiment;

FIG. 2 is a partial transparent perspective view illustrating a hardware configuration of the storage device that is an example of the first embodiment;

FIG. 3 is a schematic diagram illustrating a panel board of the storage device that is an example of the first embodiment;

FIG. 4 is a perspective view illustrating the panel board of the storage device that is an example of the first embodiment;

FIG. 5 is a graph illustrating a relationship between a heat generating component temperature T1, an uncorrected ambient temperature T2, a correction value To, and a time in the storage device that is an example of the first embodiment;

FIG. 6 is a diagram illustrating a functional configuration of a temperature measuring unit of the storage device that is an example of the first embodiment;

FIG. 7 is a flowchart illustrating a temperature measuring process in the storage device that is an example of the first embodiment;

FIG. 8 is a diagram illustrating a functional configuration of a temperature measuring unit of a storage device that is an example of a second embodiment;

FIG. 9 is a graph illustrating a principle of determining failure of temperature sensors in the storage device that is an example of the second embodiment;

FIG. 10 is a flowchart illustrating a temperature measuring process in the storage device that is an example of the second embodiment;

FIG. 11 is a schematic diagram illustrating a hardware configuration of a conventional storage device;

FIG. 12 is a diagram illustrating a temperature correction table used in the conventional storage device; and

FIG. 13 is a flowchart illustrating a temperature measuring process in the conventional storage device.

### DESCRIPTION OF EMBODIMENTS

However, the method described in the background has a problem as described below. The temperature correction table is created by performing a test under a specific temperature environment. Therefore, the correction accuracy of the ambient temperature may be degraded under a condition deviating from the temperature condition of the test.

Further, the correction values are obtained in a certain environment condition. Accordingly, the correction accuracy varies between a position air-cooled by a fan or the like and an uncooled position. Therefore, a situation occurs in which the ambient temperature is falsely detected as an abnormal temperature even though the ambient temperature is actually an appropriate temperature as an operation environment. Therefore it is desired to improve the accuracy of the ambient temperature measurement. Hereinafter, examples of embodiments will be described with reference to the drawings.

### (A) First Embodiment

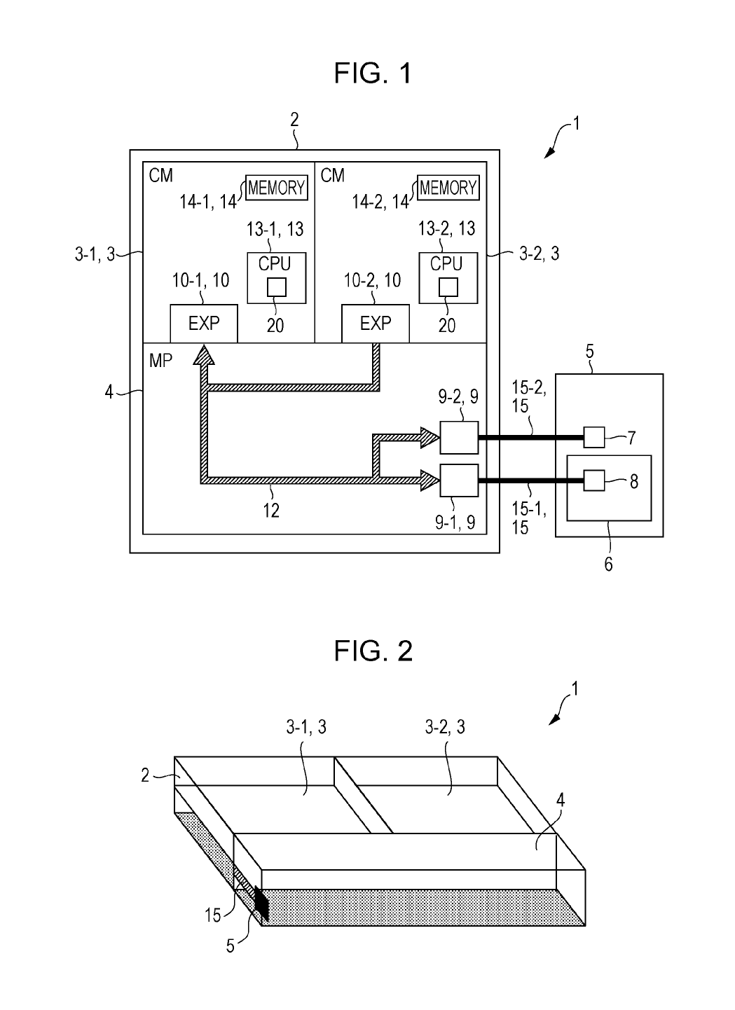

First, a configuration of a storage device 1 that is an example of a first embodiment will be described. FIG. 1 is a schematic diagram illustrating a hardware configuration of the storage device 1 that is an example of the first embodiment. FIG. 2 is a partial transparent perspective view illustrating a hardware configuration of the storage device 1.

As illustrated in FIGS. 1 and 2, the storage device 1 includes a housing 2 that houses various components of the storage device 1.

The storage device 1 includes a mid-plane board (hereinafter also referred to as MP) 4 and controller modules (CMs) 3-1 and 3-2 inside the housing 2 and includes a panel board 5 outside the housing 2. FIG. 2 perspectively illustrates the housing 2 to demonstrate a positional relationship between components housed inside the housing 2.

The MP 4 is a circuit board including a plurality of connectors on both sides of the circuit board, inter-connects circuit boards inserted into the connectors, and functions as a backbone of the storage device 1. In the present example, the MP 4 is provided with the CMs 3-1 and 3-2 described later, an HDD not illustrated in the drawings, and a power supply not illustrated in the drawings. Further, the MP 4 includes temperature sensor elements 9-1 and 9-2 described later and an I²C bus 12.

The CMs 3-1 and 3-2 control write and read of data to and from the HDD not illustrated in the drawings according to, for example, a request from a server device not illustrated in the drawings. The CM 3-1 includes an expander chip (EXP) 10-1, a CPU 13-1, and a memory 14-1. The CM 3-2 includes an EXP 10-2, a CPU 13-2, and a memory 14-2. The EXPs 10-1 and 10-2 are chips for performing input/output between the CMs 3-1 and 3-2 and an external device.

The CPUs 13-1 and 13-2 are processing devices that perform various processes by executing programs stored in the memories 14-1 and 14-2 described later. The CPUs 13-1 and 13-2 function as a temperature measuring unit (a temperature measuring device) 20 described later by executing a program. Known CPUs may be used as the CPUs 13-1 and 13-2.

The memories 14-1 and 14-2 stores programs executed by the CPUs 13-1 and 13-2, various data, and data obtained by operations of the CPUs 13-1 and 13-2. Various existing memories such as, for example, a RAM and a ROM may be used as the memories 14-1 and 14-2. A plurality of types of memories may be included in the memory 14-1 or 14-2.

The temperature sensor elements 9-1 and 9-2 include interfaces for receiving temperature date from temperature sensors 8 and 7, respectively. The temperature sensor elements 9-1 and 9-2 may include a register for correcting temperature. Hereinafter, as reference numeral that indicates a temperature sensor element, reference numeral 9-1 or 9-2 is used when identifying one of the plurality of temperature sensor elements. However, reference numeral 9 is used when specifying any one of the temperature sensor elements.

Hereinafter, as reference numeral that indicates a CM, reference numeral 3-1 or 3-2 is used when identifying one of the plurality of CMs. However, reference numeral 3 is used when specifying any one of the CMs.

The EXPs 10-1 and 10-2 have substantially the same configuration and function. Hereinafter, as reference numeral that indicates an EXP, reference numeral 10-1 or 10-2 is used when identifying one of the plurality of EXPs. However, reference numeral 10 is used when specifying any one of the EXPs.

Further, the CPUs 13-1 and 13-2 have substantially the same configuration and function. Hereinafter, as reference numeral that indicates a CPU, reference numeral 13-1 or 13-2 is used when identifying one of the plurality of CPUs. However, reference numeral 13 is used when specifying any one of the CPUs.

The memories 14-1 and 14-2 have substantially the same configuration and function. Hereinafter, as reference numeral that indicates a memory, reference numeral 14-1 or 14-2 is used when identifying one of the plurality of memories. However, reference numeral 14 is used when specifying any one of the memories.

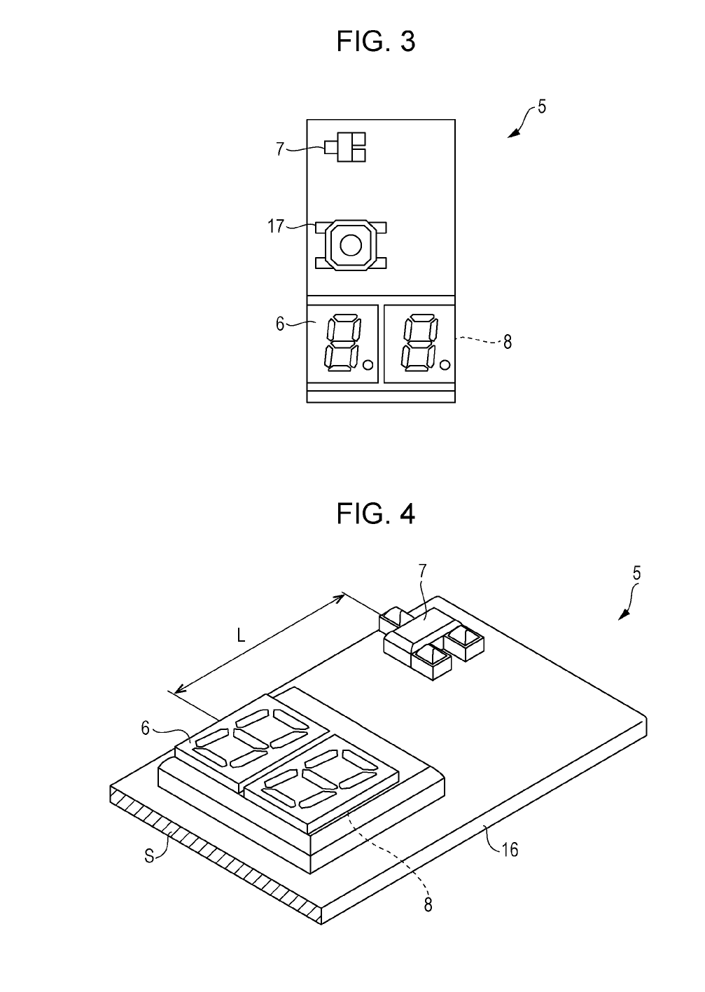

FIG. 3 is a schematic diagram illustrating the panel board 5 of the storage device 1 that is an example of the first embodiment. FIG. 4 is a perspective view illustrating the panel board 5.

The panel board 5 includes an LED 6 that indicates a conduction state and an operation state (power-on, fault, cache, and the like) of the storage device 1 on a printed circuit board 16 (see FIG. 4). The panel board 5 further includes a first temperature sensor 7 for monitoring an ambient temperature T2 (hereinafter, T2 is also referred to as an uncorrected ambient temperature) of the storage device 1. Further, a second temperature sensor 8 not illustrated in the drawings is provided on the rear surface of the panel board 5 at substantially just rear of the LED 6 in order to monitor a temperature (a heat generating component temperature) T1 of the LED 6.

The first temperature sensor 7 and the second temperature sensor 8 have substantially the same configuration and function. For example, a transistor temperature sensor may be used as the temperature sensors 7 and 8. The first temperature sensor 7 is coupled to the temperature sensor element 9 on the MP 4 through a wire connection 15. The temperature sensor element 9 is connected to the EXPs 10-1 and 10-2 through the I²C bus 12. The EXPs 10-1 and 10-2 may read values of temperatures measured by the temperature sensors 8 and 7, respectively, through the temperature sensor elements 9-1 and 9-2 by accessing the temperature sensor elements 9-1 and 9-2.

As illustrated in FIG. 3, in addition to the LED 6 for display, a switch 17 is provided on the panel board 5.

Here, as factors for the LED 6 generating heat to contribute to a temperature read value of the first temperature sensor 7, there are three factors, which are heat conduction through the printed circuit board 16, heat emission (radiation), and heat transfer (convection flow) from a solid surface (here, an LED 6 main body) to a fluid such as the atmosphere.

The most dominant factor of the three factors is the heat conduction through the printed circuit board 16. The printed circuit board 16 originally has a function as a heat sink for a heat generating component such as the LED 6 and has a high equivalent thermal conductivity. Hereinafter, heat generating components such as the LED 6 may be collectively referred to as a heat generating component 6. Therefore, a temperature measuring unit 20 that is an example of the first embodiment is intended to solve the problem caused by the heat conduction through the printed circuit board 16.

Here, an amount of heat by the heat conduction through the printed circuit board 16 is considered.

The equivalent thermal conductivity of the printed circuit board 16 is defined as k (W/m·K). As illustrated in FIG. 4, a distance from the LED 6 to the first temperature sensor 7 is defined as L (m), a cross-sectional area of the printed circuit board 16 in a direction perpendicular to the distance L is defined as S (m²), a temperature (an uncorrected ambient temperature) detected by the first temperature sensor 7 is defined as T2 (K), and a surface temperature (hereinafter also referred to as a heat generating component temperature) of the LED 6 is defined as T1 (K). Under these definitions, an amount of heat Q (J) transferred from the LED 6 to the first temperature sensor 7 in a time t (seconds) may be approximately represented by the expression 2 below.

$$Q = kSt \frac{T 1 - T 2}{L} \qquad ( Expression 2 )$$

The above expression means that the amount of transferred heat Q is proportional to the cross-sectional area S and inversely proportional to the distance L.

Next, several terms are defined as follows: ΔT (K) is a temperature rise value per unit time of the first temperature sensor 7 affected by a heat source of the LED 6, m (kg) is a mass of a main body of the first temperature sensor 7, and c (J·kg⁻¹·K⁻¹) is an equivalent specific heat of the main body of the first temperature sensor 7. Under these definitions, an amount of heat Q′ which the first temperature sensor 7 receives from outside per unit time is represented by the expression 3 below.

Q′=mcΔT (Expression 3)

In this case, the amount of heat transferred from the LED 6 to the first temperature sensor 7 is an amount of heat which the first temperature sensor 7 receives from outside, so that the expression below is established.

Q=Q′ (Expression 4)

The temperature rise value T of the first temperature sensor 7 is a sum of the temperature rise values per unit time ΔT, and the expression below is established. The temperature rise value T is notated corresponds to

$$To = \sum \frac{kS ( T 1 - T 2 )}{mcL} t = {\int }_{0}^{t} \frac{kS ( T 1 - T 2 )}{mcL} t d t \qquad ( Expression 5 )$$

The above expression means that the correction value (hereinafter also referred to as an offset value) To may be represented by a relationship among the elapsed time t (seconds) from the power-on of the device, the temperature T2 detected by the first temperature sensor 7, the heat generating component temperature T1, and a fixed parameter value kS/mcL.

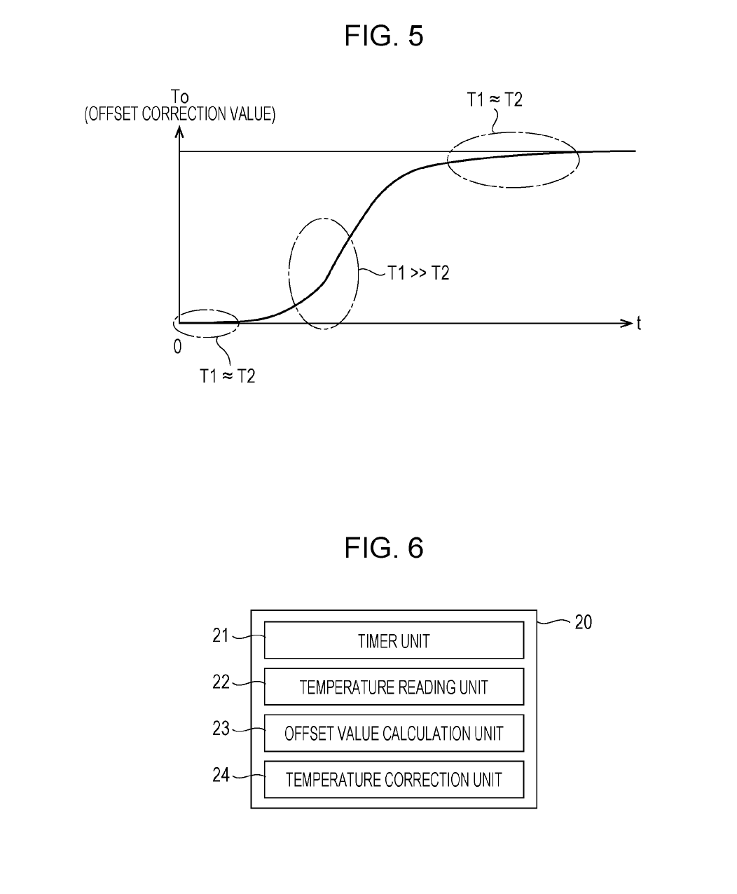

When representing a relationship between the temperature rise value T and the time t of this expression as a graph, generally, a graph illustrated in FIG. 5 is obtained.

FIG. 5 is a graph illustrating a relationship between the heat generating component temperature T1, the uncorrected ambient temperature T2, the correction value To, and the time in the storage device 1 that is an example of the first embodiment.

As illustrated in FIG. 5, immediately after the power-on, the heat generating component temperature T1 detected by the second temperature sensor 8 and the uncorrected ambient temperature T2 detected by the first temperature sensor 7 are substantially the same.

Thereafter, the temperature of the LED 6 rises and a temperature difference between the heat generating component temperature T1 and the uncorrected ambient temperature T2 detected by the first temperature sensor 7 increases, resulting in T1>>T2.

Before long, the heat generated from the LED 6 conducts to the first temperature sensor 7 and the temperature of the LED 6 (the heat generating component temperature) and the uncorrected ambient temperature T2 detected by the first temperature sensor 7 come close to each other, resulting in T1≈T2, so that, finally, the correction value To settles to an invariable value.

The ambient temperature Tc after correction may be calculated as a value obtained by subtracting the correction value (offset value) To calculated by using the expression 5 from the temperature detected by the first temperature sensor 7. In summary, the ambient temperature Tc after correction may be obtained by the following expression:

Tc=T2−To (Expression 6).

FIG. 6 is a diagram illustrating a functional configuration of the temperature measuring unit 20 of the storage device 1 that is an example of the first embodiment.

The temperature measuring unit 20 includes a timer unit 21, a temperature reading unit (a reading unit) 22, an offset value calculation unit (a calculation unit) 23, and a temperature correction unit (a correction unit) 24.

Timer unit 21 counts an elapsed time from the power-on of the storage device 1.

The temperature reading unit 22 reads temperature values read from the first temperature sensor 7 and the second temperature sensor 8 as T1 and T2, respectively, through the EXP 10 and the I²C bus 12.

The offset value calculation unit 23 calculates the offset value To by using the aforementioned expression 5 from the T1 and the T2 read by the temperature reading unit 22.

The temperature correction unit 24 calculates the ambient temperature Tc after correction by subtracting the offset value To calculated by the offset value calculation unit 23 from the T2 read by the temperature reading unit 22. Subtracting the offset value To from the T2 is referred to as “correction”.

Next, a temperature measuring process in the storage device 1 will be described.

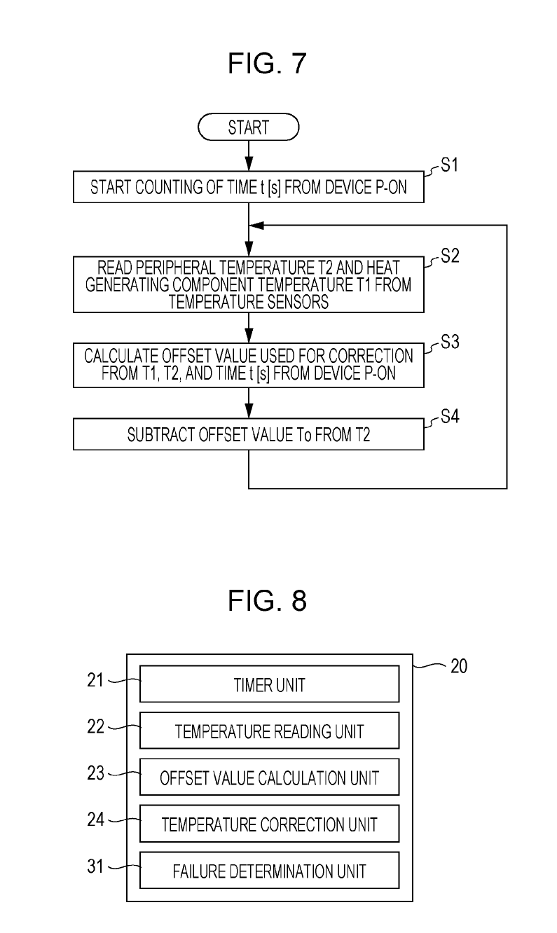

FIG. 7 is a flowchart illustrating the temperature measuring process in the storage device 1 that is an example of the first embodiment.

In step S1, the timer unit 21 in the temperature measuring unit 20 starts counting of the elapsed time t (for example, seconds) from the power-on of the storage device 1.

In step S2, the temperature reading unit 22 in the temperature measuring unit 20 reads the T1 and the T2 from the first temperature sensor 7 and the second temperature sensor 8, respectively.

Next, in step S3, the offset value calculation unit 23 calculates the offset value To by using the aforementioned expression 5 from the T1 and the T2 read by the temperature reading unit 22 in step S2.

In step S4, the temperature correction unit 24 calculates the ambient temperature Tc after correction by subtracting the correction value To obtained by the offset value calculation unit 23 in step S3 from the T2 read by the temperature reading unit 22 in step S2.

In this way, the temperature measuring unit 20 that is an example of the first embodiment calculates the offset value To used for the correction from the value read from the first temperature sensor 7, the value read from the second temperature sensor 8 for the heat generating component, and the elapsed time. Therefore, it is possible to measure the ambient temperature more accurately than a temperature correction method that uses the conventional temperature correction table because the offset value To may be more accurately determined in consideration of the influence of the rise of temperature of the heat generating component.

Since the offset value To is determined from the temperature values read from the two temperature sensors 7 and 8, for example, the offset value To may be more accurately obtained even in an environment in which air cooling is performed by a fan. Therefore, it is possible to measure the ambient temperature more accurately.

### (B) Second Embodiment

As described above, generally, the ambient temperature is defined as an operating environment in specifications of a storage device. When the storage device is running, a temperature sensor of the storage device monitors the ambient temperature so that the ambient temperature does not exceeds the ambient temperature defined in the operating environment specifications.

However, when the temperature sensor fails, it is not easy for software or firmware to detect the failure of the temperature sensor. When the temperature sensor fails, a case is assumed in which a temperature higher than the correct temperature is detected or a temperature lower than the correct temperature is detected.

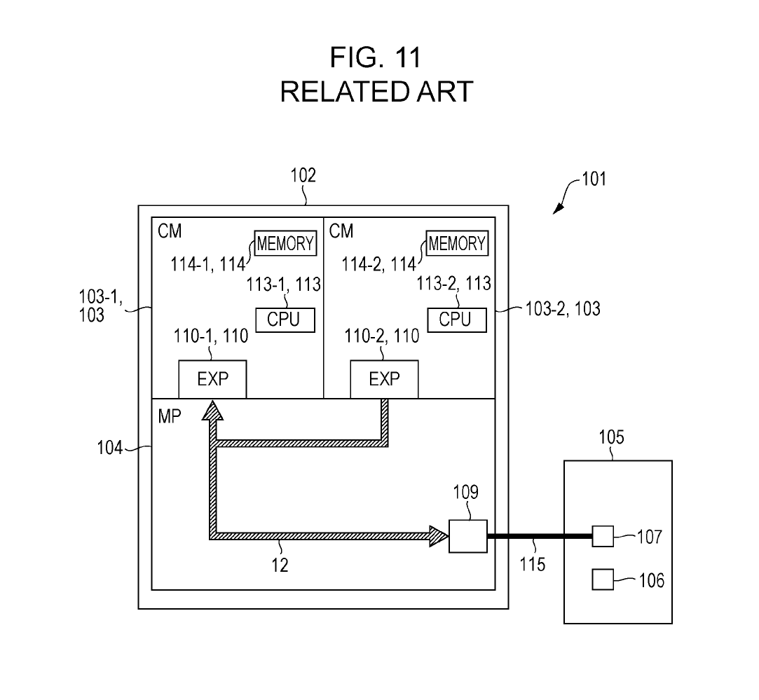

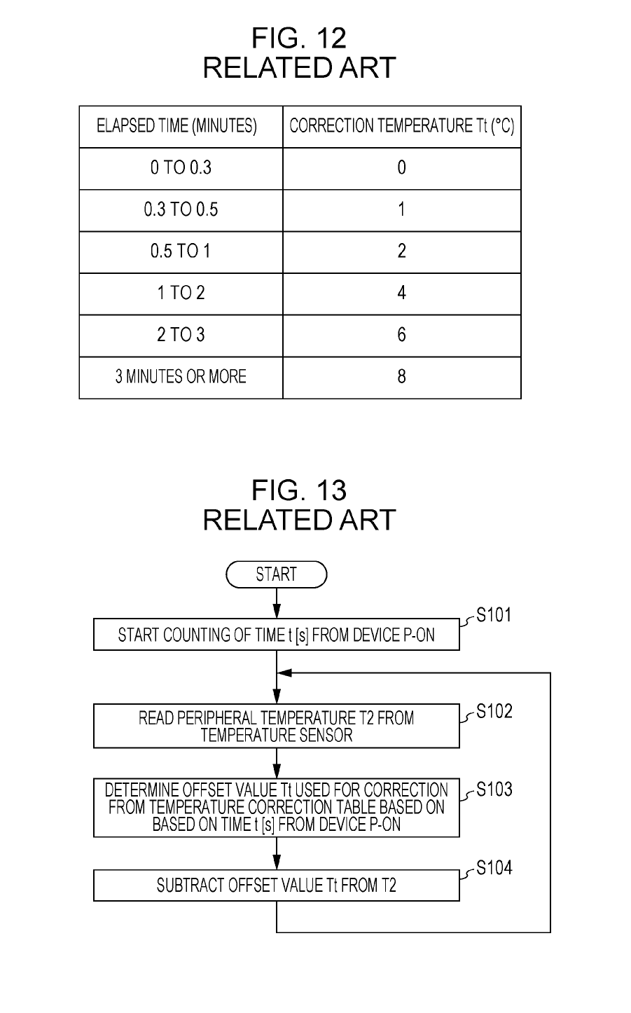

In the conventional configuration illustrated in FIG. 11, even if the value T2 read from the first temperature sensor 107 is an abnormal value, it is not possible to determine whether or not the temperature sensor 107 has a problem. Thus, a storage device 1 that is an example of a second embodiment further includes a function to detect a failure of the temperature sensors 7 and 8.

Therefore, the storage device 1 that is an example of the second embodiment includes a temperature measuring unit 30 instead of the temperature measuring unit 20 illustrated in FIG. 1.

The other components of the storage device 1 that is an example of the second embodiment are the same as those of the storage device 1 that is an example of the first embodiment illustrated in FIGS. 1 to 4, so that the descriptions and drawings thereof will be omitted.

FIG. 8 is a diagram illustrating a functional configuration of the temperature measuring unit 30 of the storage device 1 that is an example of the second embodiment.

The temperature measuring unit 30 includes a timer unit 21, a temperature reading unit 22, an offset value calculation unit 23, a temperature correction unit 24, and a failure determination unit 31. In other words, the storage device 1 that is an example of the second embodiment includes the failure determination unit 31 in addition to the temperature measuring unit 20 of the first embodiment.

Timer unit 21 counts the elapsed time from the power-on of the storage device 1. The temperature reading unit 22 reads temperature values read from the first temperature sensor 7 and the second temperature sensor 8 as T1 and T2, respectively, through the EXP 10 and the I²C bus 12. The offset value calculation unit 23 calculates the offset value To by using the aforementioned expression 5 from the T1 and T2 read by the temperature reading unit 22.

The temperature correction unit 24 calculates the ambient temperature Tc after correction by subtracting the offset value To calculated by the offset value calculation unit 23 from the T2 read by the temperature reading unit 22. The failure determination unit 31 determines the presence or absence of failure of the temperature sensors 7 and 8 from the T1 and T2 read by the temperature reading unit 22.

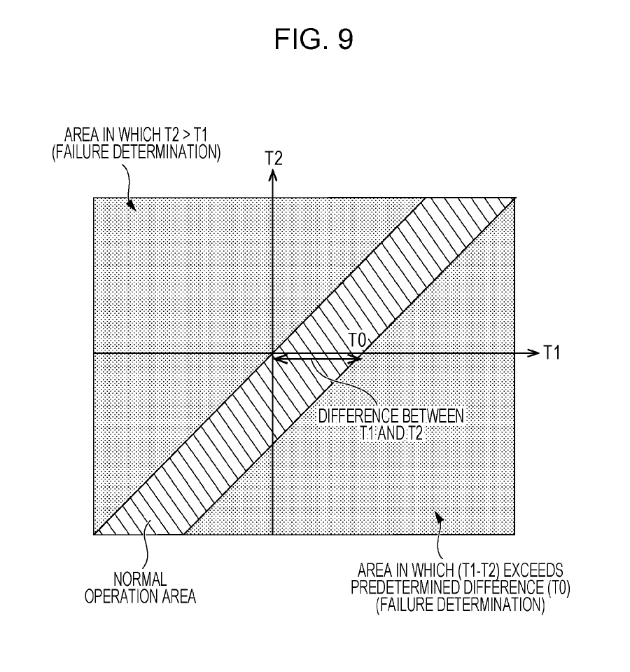

The principle of determining failure of the temperature sensors 7 and 8 by the failure determination unit 31 will be described with reference to FIG. 9.

FIG. 9 is a graph illustrating the principle of determining failure of the temperature sensors in the storage device 1 that is an example of the second embodiment. The T1 and the T2 have temperature expectation values, respectively, and the T1 and T2 satisfy the two following relationships: (a) T1 does not falls below the value of T2, and (b) a difference between T2 and T1 does not exceeds a predetermined difference (T0). An area that satisfies the two relationships is depicted as a belt-shaped area (a normal operation area) extending diagonally to the lower left in FIG. 9. On the other hand, areas outside the normal operation area are an area where T2 exceeds T1 (T2>T1) and an area where T1−T2 exceeds the predetermined difference (T0).

When the T1 and T2 read by the temperature reading unit 22 are within the normal operation area illustrated in FIG. 9, the failure determination unit 31 determines that the temperature sensors 7 and 8 are operating normally. On the other hand, when the T1 and T2 are out of the normal operation area, the failure determination unit 31 determines that at least one of the temperature sensors 7 and 8 fails. However, the failure determination unit 31 determines that at least one of the temperature sensors 7 and 8 fails only when the T1 and T2 are out of the normal operation area for a predetermined number of consecutive times (for example, for 10 consecutive times) or more to avoid false detection.

The difference T0 of T1−T2 is obtained as described below.

The power consumption of the heat generating component (for example, LED) 6 is defined as W (=Q/t). It may be assumed that when all the amount of heat corresponding to the power consumption is transferred to the temperature sensors 7 and 8, the difference T0 between T1 and T2, that is, T1−T2, becomes the maximum. Therefore, the expression below is established from the expression 2.

$$T 0 = T 1 - T 2 = \frac{WL}{kS} \qquad ( Expression 7 )$$

For example, the T0 is set in the storage device 1 before the storage device 1 is shipped from factory.

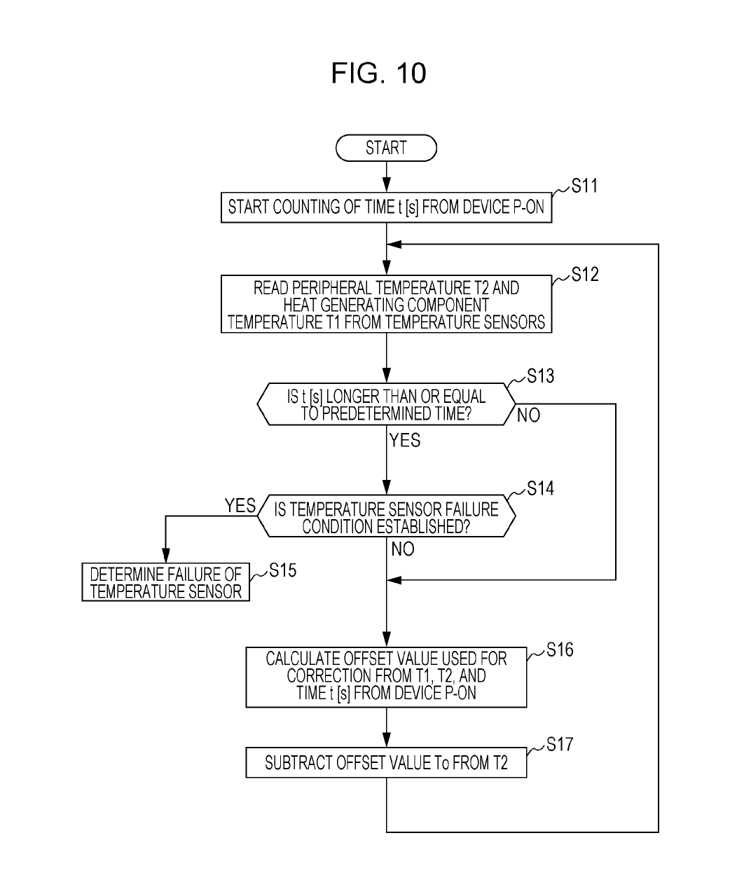

FIG. 10 is a flowchart illustrating the temperature measuring process in the storage device 1 that is an example of the second embodiment.

In step S11, the timer unit 21 in the temperature measuring unit 20 starts counting of the elapsed time t (for example, seconds) from the power-on of the storage device 1. In step S12, the temperature reading unit 22 in the temperature measuring unit 20 reads the T1 and the T2 from the first temperature sensor 7 and the second temperature sensor 8, respectively.

Next, in step S13, the timer unit 21 determines whether or not the elapsed time t from the power-on of the storage device 1 is longer than or equal to a predetermined time. The predetermined time is determined in advance by performing a test or the like and is set when the storage device 1 is shipped from factory. The predetermined time may be changed later by a user or the like.

If the elapsed time t from the power-on is shorter than the predetermined time (see NO route of step S13), even if failure determination is performed, an accurate determination result is not obtained, so that the process skips a failure determination process of the temperature sensors 7 and 8 described later and proceeds to step S16.

On the other hand, if the elapsed time t from the power-on is longer than or equal to the predetermined time (see YES route of step S13), the process proceeds to step S14. In step S14, the failure determination unit 31 performs failure determination of the temperature sensors 7 and 8 by using the graph in FIG. 9 based on the T1 and the T2 read by the temperature reading unit 22 in step S16. Specifically, the failure determination unit 31 determines whether or not the T1 and the T2 satisfy the conditions that T1 does not falls below the value of T2 and the difference between T2 and T1 does not exceeds the predetermined difference (T0).

Here, the failure determination unit 31 determines that a failure condition of the temperature sensors 7 and 8 is established only when the aforementioned conditions are not satisfied for a predetermined number of consecutive times (for example, for 10 consecutive times) or more to avoid false detection. The predetermined number of consecutive times is set when the storage device 1 is shipped from factory and may be changed later by a user or the like.

If the failure condition of the temperature sensors 7 and 8 is established (see YES route of step S14), the failure determination unit 31 determines that at least one of the temperature sensors 7 and 8 fails in step S15 and, for example, notifies a system administrator or the like of an alarm.

If the failure condition of the temperature sensors 7 and 8 is not established (see NO route of step S14), the process proceeds to step S16. In step S16, the offset value calculation unit 23 calculates the offset value To by using the aforementioned expression 5 from the T1 and the T2 read by the temperature reading unit 22 in step S12.

In step S17, the temperature correction unit 24 calculates the ambient temperature Tc after correction by subtracting the correction value To obtained by the offset value calculation unit 23 in step S16 from the T2 read by the temperature reading unit 22 in step S12.

As described above, the temperature measuring unit 30 that is an example of the second embodiment includes the failure determination unit 31 that determines a failure of the temperature sensors 7 and 8 in addition to the temperature measuring unit 20 that is an example of the first embodiment. Thereby, the temperature measuring unit 30 that is an example of the second embodiment has an effect to be able to appropriately determine a failure of the temperature sensors 7 and 8 in addition to an effect of the temperature measuring unit 20 that is an example of the first embodiment. Thereby, it is possible to avoid and/or reduce unnecessary device replacement.

### (C) Others

While the embodiments of the present disclosure have been described in detail, the present disclosure is not limited to the embodiments described above, and various changes and modifications may be made without departing from the scope of the present disclosure.

For example, although in an example of the first and the second embodiment, the LED 6 is used as an example of the heat generating component, the embodiments may be used for other heat generating components.

Although the second temperature sensor 8 is arranged on the rear surface of the panel board at a position just rear of the LED 6, the second temperature sensor 8 may be arranged at another position near the heat generating component. For example, the second temperature sensor 8 may be arranged on a side surface of the LED 6.

Although in an example of the second embodiment, the failure determination unit 31 determines that the first temperature sensor 7 or 8 fails when a failure condition is satisfied for a predetermined number of consecutive times or more, the failure determination unit 31 may determine that the first temperature sensor 7 or 8 fails when the failure condition is satisfied only once.

A program that realizes functions of the temperature measuring units 20 and 30, the timer unit 21, the temperature reading unit 22, the offset value calculation unit 23, the temperature correction unit 24, and the failure determination unit 31 is provided in a form recorded in a computer-readable recording medium such as a flexible disk, a CD (CD-ROM, CD-R, CD-RW, and the like), a DVD (DVD-ROM, DVD-RAM, DVD-R, DVD+R, DVD-RW, DVD+RW, HD DVD, and the like), a Blu-ray Disc, a magnetic disk, an optical disk, and a magneto-optical disk. A computer reads the program from the recording medium through a medium reader not illustrated in the drawings, transfers and stores the program in an internal storage device or an external storage device, and uses the program. Or, the program may be recorded in a storage device (a recording medium) such as, for example, a magnetic disk, an optical disk, and a magneto-optical disk and may be provided to the computer from the storage device through a communication path.

When realizing the functions of the temperature measuring units 20 and 30, the timer unit 21, the temperature reading unit 22, the offset value calculation unit 23, the temperature correction unit 24, and the failure determination unit 31, the program stored in an internal storage device (the memory 14 in the CM 3 in the embodiments) is executed by a microprocessor (the CPU 13 in the CM 3 in the embodiments) of the computer. At this time, the computer may read and execute the program recorded in a recording medium.

The functions of the temperature measuring units 20 and 30, the timer unit 21, the temperature reading unit 22, the offset value calculation unit 23, the temperature correction unit 24, and the failure determination unit 31 may be realized by firmware (not illustrated in the drawings) provided in the CM 3 and the EXP 10.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A temperature measuring device comprising:
a reading unit configured to read a first temperature value from a first temperature sensor that measures a temperature of a heat generating component and a second temperature value from a second temperature sensor that measures an ambient temperature;
a calculation unit configured to calculate a correction value from an elapsed time and the first and the second temperature values; and
a correction unit configured to calculate an corrected ambient temperature by correcting the second temperature value using the correction value obtained by the calculation unit.

2. The temperature measuring device according to claim 1, further comprising:
a failure determination unit configured to determine presence or absence of failure of at least one of the first temperature sensor and the second temperature sensor on the basis of the first and the second temperature values.

3. The temperature measuring device according to claim 2,
wherein the failure determination unit determines that at least one of the first temperature sensor and the second temperature sensor fails when the second temperature value exceeds the first temperature value or a difference obtained by subtracting the second temperature value from the first temperature value exceeds a certain threshold value.

4. The temperature measuring device according to claim 1,
wherein the calculation unit calculates the correction value on the basis of heat conduction through a printed circuit board on which the first temperature sensor and the second temperature sensor are mounted.

5. A storage device comprising:
a heat generating component;
a first temperature sensor configured to measure a temperature of the heat generating component;
a second temperature sensor configured to measure an ambient temperature;
a reading unit configured to read a first temperature value from the first temperature sensor and a second temperature value from the second temperature sensor;
a calculation unit configured to calculate a correction value from an elapsed time and the first and the second temperature values; and
a correction unit configured to calculate a corrected ambient temperature by correcting the second temperature value using the correction value obtained by the calculation unit.

6. The storage device according to claim 5, further comprising:
a failure determination unit configured to determine presence or absence of failure of at least one of the first temperature sensor and the second temperature sensor based on the first and the second temperature values.

7. The storage device according to claim 6,
wherein the failure determination unit determines that at least one of the first temperature sensor and the second temperature sensor fails when the second temperature value exceeds the first temperature value or a difference obtained by subtracting the second temperature value from the first temperature value exceeds a predetermined threshold value.

8. The storage device according to claim 5,
wherein the calculation unit calculates the correction value based on heat conduction through a printed circuit board on which the first temperature sensor and the second temperature sensor are mounted.

9. A temperature measuring method comprising:
reading a first temperature value from a first temperature sensor that measures a temperature of a heat generating component and a second temperature value from a second temperature sensor that measures an ambient temperature;
calculating a correction value from an elapsed time and the first and the second temperature values; and
calculating an corrected ambient temperature by correcting the second temperature value using the calculated correction value.

10. The temperature measuring method according to claim 9,
wherein presence or absence of failure of at least one of the first temperature sensor and the second temperature sensor is determined on the basis of the first and the second temperature values.

11. The temperature measuring method according to claim 10,
wherein it is determined that at least one of the first temperature sensor and the second temperature sensor fails when the second temperature value exceeds the first temperature value or a difference obtained by subtracting the second temperature value from the first temperature value exceeds a predetermined threshold value.

12. The temperature measuring method according to claim 9,
wherein the correction value is calculated based on heat conduction through a printed circuit board on which the first temperature sensor and the second temperature sensor are mounted.
